(19) United States
(12) Patent Application Publication
(10) Pub. No.: US 2014/0069675 A1
(43) Pub. Date: Mar. 13, 2014

(54) SPINDLE BEARING ARRANGEMENT FOR A POWER TOOL

(71) Applicant: Black & Decker Inc., Newark, DE (US)

(72) Inventors: Qiang Zhang, Lutherville, MD (US); David C. Tomayko, Ellicott City, MD (US); Sankarshan Murthy, Mountain View, CA (US); James T. Rill, Hampstead, MD (US)

(73) Assignee: Black & Decker Inc., Newark, DE (US)

(21) Appl. No.: 14/081,083

(22) Filed: Nov. 15, 2013

Related U.S. Application Data
(63) Continuation of application No. 12/729,867, filed on Mar. 23, 2010, now Pat. No. 8,584,770.

(51) Int. Cl. B25F 5/00; B23Q 5/04

(52) U.S. Cl. CPC B25F 5/001; B23Q 5/04
USPC 173/178; 173/216

(57) ABSTRACT

A power tool that includes a housing, a motor, a pair of motor bearings, a transmission, an output spindle and front and rear spindle bearings. The motor is received in the housing and includes a stator and an output shaft that extends through the stator. The motor bearings support the output shaft for rotation relative to the housing and are disposed on opposite ends of the stator. The transmission is driven by the motor and includes an input pinion that is mounted to the output shaft for rotation therewith. The output spindle is driven by the transmission. The front spindle bearing is mounted to a front end of the output shaft radially between the housing and the output shaft. The rear spindle bearing is mounted to a rear end of the output spindle and a portion of the rear spindle bearing rotates with the output shaft.

### CROSS-REFERENCE TO RELATED APPLICATIONS

This application is a continuation of U.S. patent application Ser. No. 12/729,867 filed Mar. 23, 2010 (now U.S. Pat. No. 8,584,770), the entire disclosure of which is incorporated by reference as if fully set forth in detail herein.

### FIELD

The present disclosure relates to a spindle bearing arrangement for a power tool.

### BACKGROUND

U.S. Pat. No. 6,431,289 and U.S. patent application Ser. No. 12/610,762 disclose various rotary power tools having an output spindle, which is driven by a planetary-type transmission, and a torque limiting clutch for selectively limiting an output torque of the rotary power tool. While such rotary power tools are satisfactory for their intended purposes, such rotary power tools are nonetheless susceptible to improvement.

### SUMMARY

This section provides a general summary of the disclosure, and is not a comprehensive disclosure of its full scope or all of its features.

In one form, the teachings of the present disclosure provide a power tool having a motor, a housing, a transmission, an output spindle, a first bearing and a second bearing. The motor has an output shaft. The transmission is at least partly disposed in the housing and receives a rotary input from the output shaft. The transmission includes a planet carrier. The output spindle is driven by the transmission and includes a first end, which is supported for rotation about a spindle axis by the planet carrier, and a second end opposite the first end. The first bearing is disposed between the housing and the planet carrier and supports the planet carrier for rotation about the spindle axis. The second bearing is disposed between the housing and the output spindle and is configured to support the output spindle for rotation about the spindle axis at a location proximate the second end.

In another form, the teachings of the present disclosure provide a power tool with a motor, a housing, a transmission, an output spindle, a front bearing and a rear bearing. The motor has an output shaft. The transmission is disposed in the housing and receives a rotary input from the output shaft. The transmission includes an input planetary stage, which has an input planet carrier, and an output planetary stage. The output spindle is driven by the transmission and has a first end, which extends at least partly through the input planetary stage, and a second end opposite the first end. The front bearing is disposed between the output spindle and the housing to support the second end of the output spindle for rotation about the spindle axis. The rear bearing indirectly supports the first end of the output spindle in the housing for rotation about the spindle axis.

In still another form, the present disclosure provides a power tool that includes a motor, a housing, a transmission, an output spindle, a spindle lock and front and rear bearings. The motor has an output shaft. The transmission is disposed in the housing and receives a rotary input from the output shaft. The transmission includes an input planetary stage, which has an input planet carrier, and an output planetary stage. The output spindle is driven by the transmission and is received through the output planetary stage such that the first end extends at least partly through the input planetary stage. The spindle lock is mounted on the output spindle between the first and second ends. The front and rear bearings, which are disposed on opposite sides of the spindle lock, support the output spindle relative to the housing for rotation about a spindle axis.

In yet another form, the present teachings provide a power tool that includes a housing, a motor, a pair of motor bearings, a transmission, an output spindle and front and rear spindle bearings. The motor is received in the housing and includes a stator and an output shaft that extends through the stator. The motor bearings support the output shaft for rotation relative to the housing and are disposed on opposite ends of the stator. The transmission is driven by the motor and includes an input pinion that is mounted to the output shaft for rotation therewith. The output spindle is driven by the transmission. The front spindle bearing is mounted to a front end of the output shaft radially between the housing and the output shaft. The rear spindle bearing is mounted to a rear end of the output spindle and a portion of the rear spindle bearing rotates with the output shaft.

In still another form, the present teachings provide a power tool that includes a housing, a motor received in the housing, a transmission driven by the motor, an output spindle driven by the transmission and front and rear spindle bearings. The transmission has an input pinion that is mounted to an output shaft of the motor for rotation therewith. The front spindle bearing is mounted to a front end of the output shaft radially between the housing and the output shaft. The rear spindle bearing is mounted to a rear end of the output spindle. The rear spindle bearing is supported by the output shaft.

In a further form, the present teachings provide a power tool that includes a housing, a motor received in the housing, a pair of motor bearings, a transmission driven by the motor, an output spindle driven by the transmission, and front and rear spindle bearings. The motor has a stator and an output shaft that extends through the stator. The motor bearings support the output shaft for rotation relative to the housing and are disposed on opposite ends of the stator. The transmission has an input pinion that is mounted to the output shaft for rotation therewith. The front spindle bearing is mounted to a front end of the output shaft radially between the housing and the output shaft. The rear spindle bearing is mounted to a rear end of the output spindle and is not directly mounted to the housing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevation view of an exemplary tool constructed in accordance with the teachings of the present disclosure;

FIG. 2 is an exploded perspective view of the tool of FIG. 1;

FIG. 3 is a longitudinal section view of a portion of the tool of FIG. 1; and

FIGS. 4 through 6 are section views of portions of five other tools constructed in accordance with the teachings of the present disclosure.

Corresponding reference numerals indicate corresponding parts throughout the several views of the drawings.

### DETAILED DESCRIPTION

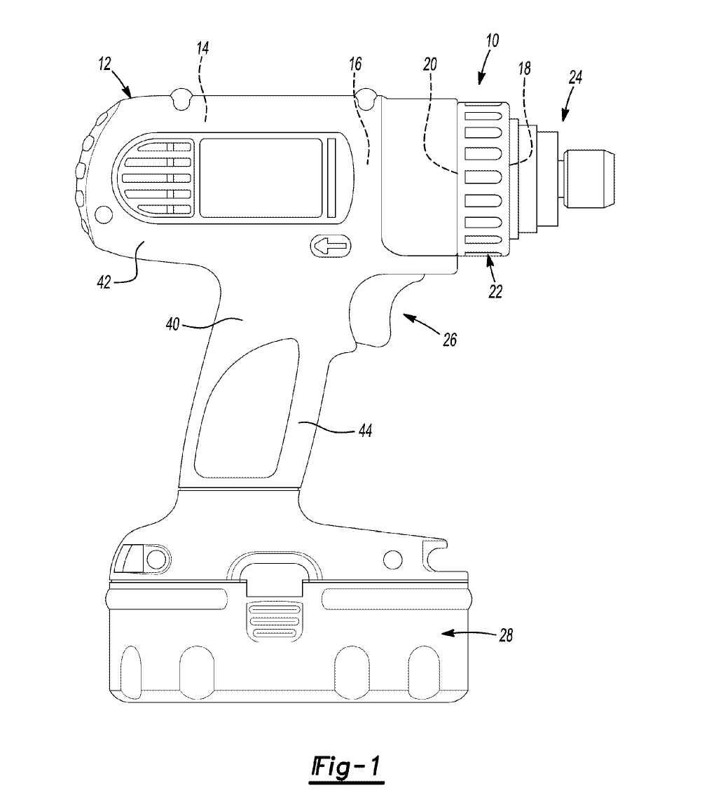

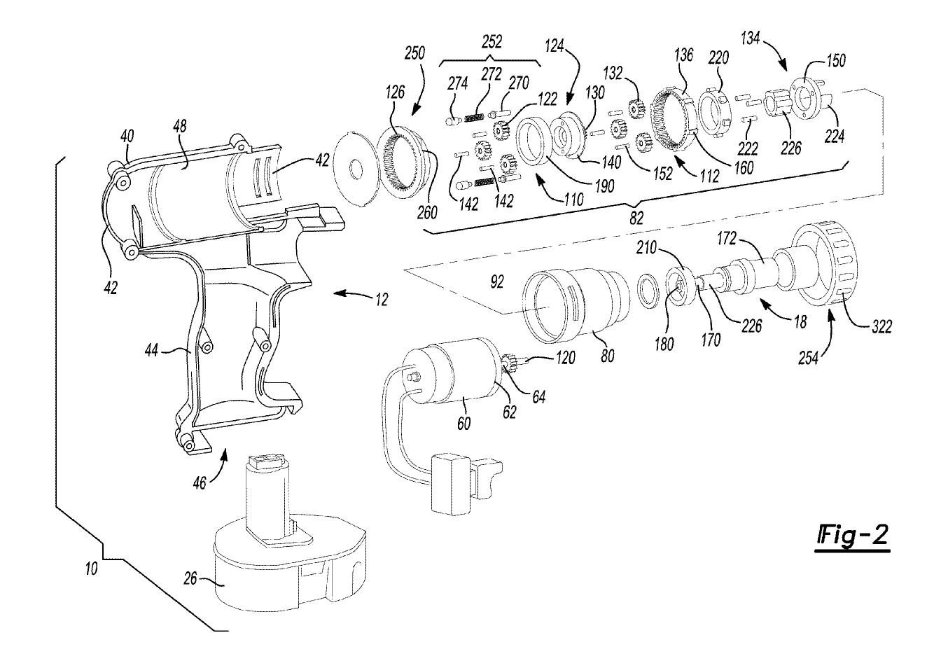

With reference to FIGS. 1 and 2 of the drawings, a power tool constructed in accordance with the teachings of the present disclosure is generally indicated by reference numeral 10. As those skilled in the art will appreciate, the power tool 10 may be either a corded (e.g., AC powered) or cordless (e.g., DC battery operated) device, such as a portable screwdriver, impact driver, drill/driver or hammer drill/drill. In the particular embodiment illustrated, the power tool 10 is a cordless screwdriver having a housing 12, a motor assembly 14, a transmission assembly 16, an output spindle 18, a spindle lock 20, a clutch mechanism 22, a chuck 24, a trigger assembly 26 and a battery pack 28. Those skilled in the art will understand that several of the components of power tool 10, such as the chuck 24, the trigger assembly 26 and the battery pack 28, are conventional in nature and need not be described in significant detail in this application. Reference may be made to a variety of publications for a more complete understanding of the operation of the conventional features of power tool 10. One example of such publications is commonly assigned U.S. Pat. No. 5,897,454 issued Apr. 27, 1999, the disclosure of which is hereby incorporated by reference as if fully set forth herein.

The housing 12 can include a pair of clam shell housing halves 40 only one shown in FIG. 2) that can cooperate to define a body 42, a handle 44 and a battery interface 46 that can be configured to receive the battery pack 28. The handle 44 can house the trigger assembly 26 in a conventional manner, while the body 42 can define a motor cavity 48 into which the motor assembly 14 can be received. The housing 12 can be configured with an exterior gear case housing (not shown) that can be coupled to a front side of the body 42 and configured to shroud or cover all or portions of the transmission assembly 16 and clutch mechanism 22. In the particular example provided, however, the clam shell housing halves 40 are configured to shroud or cover the transmission assembly 16 and the clutch mechanism 22.

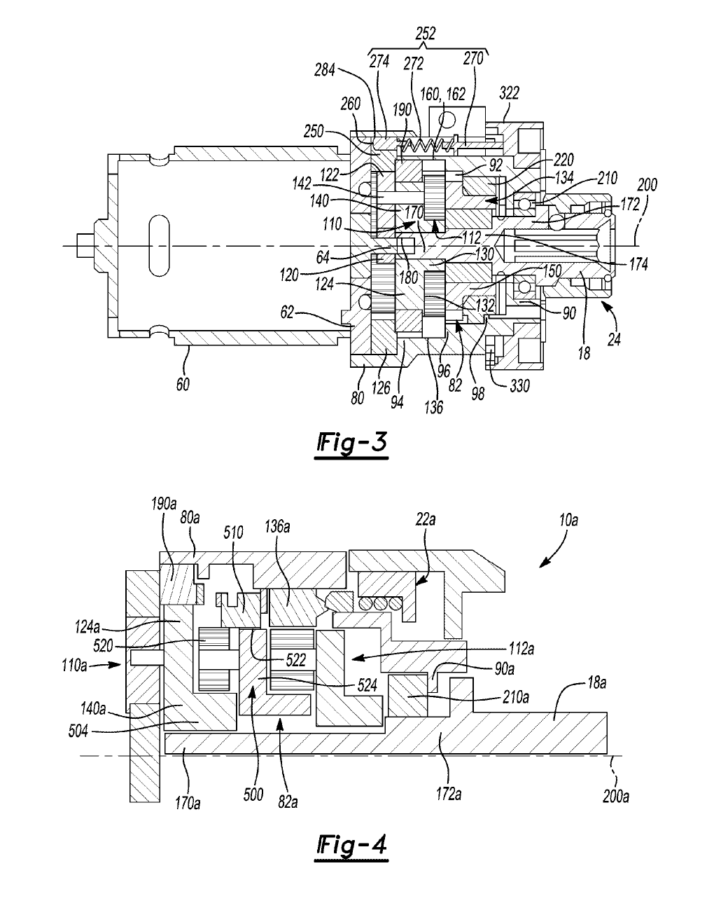

With reference to FIGS. 2 and 3, the motor assembly 14 can comprise a motor 60 and an adapter plate 62. The motor 60 can be any type of motor, such as a DC electric motor, and can include an output shaft 64. The motor 60 can be received in the motor cavity 48 and can be electrically coupled to the trigger assembly 26 and the battery pack 28. The adapter plate 62 can be fixedly coupled to an end of the motor 60.

The transmission assembly 16 can comprise a transmission housing 80 and a transmission 82. The transmission housing 80 can be a hollow, generally tubular structure that is configured to house the transmission 82 and portions of the clutch mechanism 22. The transmission housing 80 can be received into the motor cavity 48 and can engage the clam shell housing halves 40 such that the transmission housing 80 is axially fixed and non-rotatably engaged to the housing 12. The transmission housing 80 can define a front bearing mount 90 and a central cavity 92 having a first shoulder 94, a second shoulder 96 and a third shoulder 98.

The transmission 82 can be a planetary-type transmission having an input planetary stage 110 and an output planetary stage 112 that can be received in the central cavity 92 of the transmission housing 80. It will be appreciated that although the particular transmission depicted and described herein is a two-stage, single speed transmission, the teachings of the present disclosure have application to other types of transmissions, including those that are operable in more than one speed ratio and/or those that comprise fewer or more than two planetary stages (i.e., a single stage planetary transmission or a transmission having at least one planetary stage disposed between the input and output planetary stages 110 and 112). The input planetary stage 110 can comprise an input sun gear 120, a plurality of input planet gears 122, an input planet carrier 124 and an input ring gear 126, while the output planetary stage 112 can comprise an output sun gear 130, a plurality of output planet gears 132, an output planet carrier 134 and an output ring gear 136.

The input sun gear 120 can be mounted on the output shaft 64 of the motor 60 for rotation therewith. The input planet gears 122 can be meshingly engaged with the input sun gear 120 and the input ring gear 126. The input planet carrier 124 can comprise a carrier body 140 and a plurality of pins 142 that can be mounted to the carrier body 140. Each of the input planet gears 122 can be rotatably mounted on a respective one of the pins 142. The input ring gear 126 can be abutted against the first shoulder 94. The adapter plate 62 can be received in the central cavity 92 and non-rotatably coupled to the transmission housing 80 to thereby limit rearward axial movement of the input ring gear 126 relative to the transmission housing 80, as well as to inhibit rotation of the motor 60 relative to the transmission housing 80.

The output sun gear 130 can be coupled to the carrier body 140 of the input planet carrier 124 for rotation therewith. The output planet gears 132 can be meshingly engaged with the output sun gear 130 and the output ring gear 136. The output planet carrier 134 can comprise a carrier body 150 and a plurality of pins 152 that can be mounted to the carrier body 150. Each of the output planet gears 132 can be rotatably mounted on a respective one of the pins 152 of the output carrier 134. The output ring gear 136 can be abutted against the second shoulder 96 and non-rotatably engaged to the transmission housing 80. In the particular example provided, the output ring gear 136 includes a plurality of external teeth 160 that are engaged to internal teeth 162 formed on the interior of the transmission housing 80 proximate the second shoulder 96.

The output spindle 18 can be a unitarily formed shaft structure that can be received at least partially through the transmission 82. The output spindle 18 can comprise a rear end 170, a front end 172 and an anvil mount 174 that can be disposed between the rear and front ends 170 and 172. The rear end 170 can be generally cylindrically shaped and can extend fully or partly through the input planetary stage 110 where it can be supported for rotation by an element of the transmission 82. For example, the rear end 170 can extend through or into at least one of the output sun gear 130 and the carrier body 140 of the input planet carrier 124 such that the input planet carrier 124 supports the rear end 170 of the output spindle 18. The output shaft 64 of the motor 60 can be received in an appropriately sized aperture 180 in the rear end 170 of the output spindle 18.

A suitable rear bearing 190, such as a journal bearing or bushing, can be disposed between the transmission housing 80 and the carrier body 140 of the input planet carrier 124 to support the input planet carrier 124 for rotation about a spindle axis 200. It will be appreciated that the rear bearing 190, which can be disposed axially between the input ring gear 126 and the output ring gear 136, can indirectly support the rear end 170 of the output spindle 18 about the spindle axis 200.

A suitable front bearing 210, such as a ball bearing, can be disposed in the front bearing mount 90 between the transmission housing 80 and the front end 172 of the output spindle 18. The front end 172 can be configured to transmit rearwardly-directed thrust loads into the front bearing 210 so that they may be transmitted into the transmission housing 80. One or more snap rings or other retaining devices can be employed to limit axial movement of the front bearing 210 on the front end 172 of the output spindle 18.

The spindle lock 20 can comprise an outer collar 220, a plurality of lock pins 222, a plurality of projections 224, which can be integrally formed with the carrier body 150 of the output planet carrier 134, and an anvil 226. The outer collar 220 can be an annular structure that can be received against the third shoulder 98 in the central cavity 92 and non-rotatably engaged to the transmission housing 80. The lock pins 222 can extend longitudinally parallel to the spindle axis 200 between the projections 224 and an interior surface of the outer collar 220. The anvil 226 can be mounted on the anvil mount 174 on the output spindle 18 such that the anvil 226 is coupled to the output spindle 18 for rotation therewith. The spindle lock 20 is configured to permit the output spindle 18 to rotatably driven by the transmission 82, but to lock the output spindle 18 to the transmission housing 80 (to thereby inhibit rotation of the output spindle 18) when the output spindle 18 is rotated manually.

The clutch mechanism 22 can include a clutch member 250, one or more engagement assemblies 252 and an adjustment mechanism 254. The clutch member 250 can be an annular structure that can be fixedly coupled to the input ring gear 126. In the particular example provided, the clutch member 250 includes an arcuate clutch face 260 that is formed into an axially forward facing side of the input ring gear 126. The outer diameter of the clutch member 250 is sized to rotate within the portion of the central cavity 92 that is proximate the first shoulder 94 in the transmission housing 80. While the input ring gear 126 and the clutch member 250 have been illustrated as a one piece (i.e., unitarily formed) construction, those skilled in the art will understand that they may be constructed otherwise.

In the particular embodiment illustrated, the engagement assemblies 252 are disposed 180° apart from one another (only one is shown in FIG. 3 for clarity) and each engagement assembly 252 includes a pin member 270, a follower spring 272 and a follower 274. The pin member 270 includes a cylindrical body portion 280 having an outer diameter that is sized to slip-fit within an actuator aperture 284 that is formed through the transmission housing 80. A first end of the pin member 270 can have an end that can be defined by a spherical radius and can be configured to engage the adjustment mechanism 254.

The follower spring 272 can be a compression spring whose outside diameter is sized to slip fit within the actuator aperture 284. The forward end of the follower spring 272 can contacts the pin member 270, while the opposite end of the follower spring 272 can contact the follower 274. An end portion of the follower 274 can be cylindrical in shape and sized to slip fit within the inside diameter of the follower spring 272. In this regard, the end portion of the follower 274 can act as a spring follower to prevent the follower spring 272 from bending over when it is compressed. The follower 274 can also include a cylindrically shaped body portion, which can be sized to slip fit within the actuator aperture 284, and a tip portion that is configured to extend axially through the first shoulder 94 and engage the clutch face 260. In the particular example illustrated, the tip portion is defined by a spherical radius.

The adjustment mechanism 254 can include a setting collar 322 can be shaped in the form of a generally hollow cylinder that is sized to fit and cover a front end of the housing 12. The setting collar 322 can include an annular face into which an adjustment profile 330 is formed. The adjustment profile 330 can be tapered or stepped such that rotation of the setting collar 322 will cause corresponding axial movement of the pin member 270, which operates to change the torque setting of the clutch mechanism 22 as a result of corresponding compression or extension of the follower spring 272.

The setting collar 322 can include a contoured outer surface that can permit the user of the tool 10 to comfortably rotate both the setting collar 322 to set the adjustment profile 330 at a position corresponding to a desired torque setting of the clutch mechanism 22.

During the operation of the tool 10, an initial drive torque is transmitted by the output shaft 64 of the motor 60 to the input planetary stage 110, causing the input planet gears 122 to rotate. Rotation of the input planet gears 122 creates a first intermediate torque that is applied against the input ring gear 126. A clutch torque applied by the clutch mechanism 22 resists the first intermediate torque to thereby prevent the input ring gear 126 from rotating within the transmission housing 80 such that the first intermediate torque is applied to the input planet carrier 124 and the remainder of the transmission 82 so as to multiply the first intermediate torque in a predetermined manner according to the reduction ratio of the transmission 82.

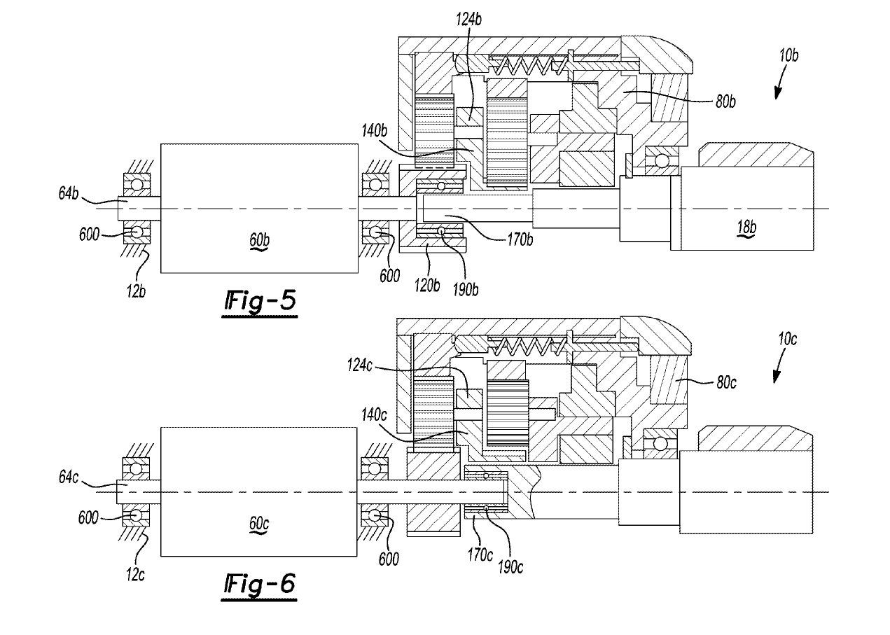

A portion of another power tool 10a constructed in accordance with the teachings of the present disclosure is schematically illustrated in FIG. 4. In the example provided, the transmission 82a includes an input planetary stage 110a, an intermediate planetary stage 500, and an output planetary stage 112a. The output spindle 18a extends through the transmission 82a such that the rear end 170a of the output spindle 18a is received through or into at least one of an intermediate sun gear 504 (which is associated with the intermediate planetary stage 500) and the carrier body 140a of the input planet carrier 124a such that the input planet carrier 124a supports the rear end 170a of the output spindle 18a. The rear bearing 190a can be disposed between the transmission housing 80a and an element of the transmission 82a located rearwardly of the final or output stage of the transmission 82a (i.e., rearwardly of the output planetary stage 112a). In the particular example provided, the rear bearing 190a is disposed between the transmission housing 80a and the carrier body 140a of the input planet carrier 124a to support the input planet carrier 124a for rotation about the spindle axis 200a. As with the previous example, the front bearing 210a is received in a front bearing mount 90a formed in a transmission housing 80a and cooperates to align front end 172a of the output spindle 18a to the spindle axis 200a.

In the particular example provided, the transmission 82a is a two-speed, three-stage planetary-type transmission in which a ring gear 510 associated with the intermediate planetary stage 500 is movable between a first position (shown), in which the ring gear 510 is meshingly engaged to the planet gears 520 and a toothed exterior surface 522 of the planet carrier 524 of the intermediate planetary stage 500, and a second position in which the ring gear 510 is translated axially rearwardly so as to non-rotatably engage the rear bearing 190a and disengage the toothed exterior surface 522 of the planet carrier 524 of the intermediate planetary stage 500. Moreover, the clutch mechanism 22a is configured to resist rotation of the output ring gear 136a.

A portion of another power tool 10b constructed in accordance with the teachings of the present disclosure is schematically illustrated in FIG. 5. This example is generally similar to that of FIGS. 1-3, except that a pair of motor bearings 600 support the output shaft 64b (relative to the housing 12b) on opposite sides of the motor 60b, the output spindle 18b extends into the input sun gear 120b, the output shaft 64b of the motor 60b does not extend into the rear end 170b of the output spindle 18b, and the rear bearing 190b is received between the input sun gear 120b and the rear end 170b of the output spindle 18b (rather than between the carrier body 140b of the input planet carrier 124b and the transmission housing 80b).

A portion of another power tool 10c constructed in accordance with the teachings of the present disclosure is schematically illustrated in FIG. 6. This example is generally similar to that of FIGS. 1-3, except that a pair of motor bearings 600 support the output shaft 64c (relative to the housing 12c) on opposite sides of the motor 64c and the rear bearing 190c is received between the output shaft 64c of the motor 60c and the rear end 170c of the output spindle 18c (rather than between the carrier body 140c of the input planet carrier 124c and the transmission housing 80c).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A power tool comprising:
a housing;
a motor received in the housing, the motor having a stator and an output shaft that extends through the stator;
a pair of motor bearings supporting the output shaft for rotation relative to the housing, the motor bearings being disposed on opposite ends of the stator;
a transmission driven by the motor, the transmission having an input pinion that is mounted to the output shaft for rotation therewith;
an output spindle driven by the transmission;
a front spindle bearing mounted to a front end of the output shaft radially between the housing and the output shaft; and
a rear spindle bearing mounted to a rear end of the output spindle, wherein a portion of the rear spindle bearing rotates with the output shaft.

2. The power tool of claim 1, wherein the output shaft extends through the input pinion.

3. The power tool of claim 2, wherein the rear spindle bearing is received in an aperture formed in the rear end of the output spindle.

4. The power tool of claim 1, wherein the rear spindle bearing is at least partly received in the input pinion.

5. The power tool of claim 1, wherein the rear spindle bearing is mounted on the input pinion.

6. The power tool of claim 1, wherein the front end of the output shaft has a first diameter, wherein the rear end of the output shaft has a second diameter, and wherein the first diameter is greater than the second diameter.

7. The power tool of claim 1, further comprising a clutch assembly that is configured to limit torque transmission through the transmission to the output spindle.

8. The power tool of claim 1, wherein the transmission is a multi-stage planetary transmission having an output stage with a planet carrier, and wherein the output spindle is coupled to the planet carrier for rotation therewith.

9. A power tool comprising:
a housing;
a motor received in the housing, the motor having an output shaft;
a transmission driven by the motor, the transmission having an input pinion that is mounted to the output shaft for rotation therewith;
an output spindle driven by the transmission;
a front spindle bearing mounted to a front end of the output shaft radially between the housing and the output shaft; and
a rear spindle bearing mounted to a rear end of the output spindle, wherein the rear spindle bearing is supported by the output shaft.

10. The power tool of claim 9, wherein the rear spindle bearing is directly mounted to the rear output shaft.

11. The power tool of claim 9, wherein the output shaft extends through the input pinion.

12. The power tool of claim 9, wherein the rear spindle bearing is directly mounted to the input pinion.

13. The power tool of claim 12, wherein the rear spindle bearing is received in an aperture formed in the input pinion.

14. The power tool of claim 9, further comprising a clutch assembly that is configured to limit torque transmission through the transmission to the output spindle.

15. The power tool of claim 9, wherein the transmission is a multi-stage planetary transmission having an output stage with a planet carrier, and wherein the output spindle is coupled to the planet carrier for rotation therewith.

16. A power tool comprising:
a housing;
a motor received in the housing, the motor having a stator and an output shaft that extends through the stator;
a pair of motor bearings supporting the output shaft for rotation relative to the housing, the motor bearings being disposed on opposite ends of the stator;
a transmission driven by the motor, the transmission having an input pinion that is mounted to the output shaft for rotation therewith;
an output spindle driven by the transmission;
a front spindle bearing mounted to a front end of the output shaft radially between the housing and the output shaft; and
a rear spindle bearing mounted to a rear end of the output spindle, wherein the rear spindle bearing is not directly mounted to the housing.

17. The power tool of claim 16, wherein the rear spindle bearing is mounted to an element of the transmission such that the rear spindle bearing is disposed radially between the element of the transmission and the rear end of the output spindle.

18. The power tool of claim 17, wherein the element of the transmission is the input pinion.

19. The power tool of claim 16, wherein the output shaft extends through the input pinion.

20. The power tool of claim 16, wherein the rear spindle bearing is mounted to the output shaft such that the rear spindle bearing is disposed radially between the rear end of the output spindle and the output shaft.
